(19) United States
(12) Patent Application Publication
(10) Pub. No.: US 2010/0262517 A1
(43) Pub. Date: Oct. 14, 2010

(54) Systems and Methods for Displaying Goods

(76) Inventor: Melanie Woods, Coburg (AU)

Correspondence Address: LETHAM LAW FIRM, LLC, 914 N. TUCANA LANE, GILBERT, AZ, 85234, US

(21) Appl. No.: 12/756,347

(22) Filed: Apr. 8, 2010

(30) Foreign Application Priority Data
Apr. 8, 2009 (AU) 2009901529

(51) Int. Cl. H04N 7/14; G06Q 30/00; G06F 3/048

(52) U.S. Cl. 705/27; 348/14.01; 715/719; 715/757; 715/742

(57) ABSTRACT

Systems and methods that enable a customer to receive assistance from a staff member located in a store that is remote from the location of the customer. The system and methods enabled the customer to request information from the staff member about a product and the staff member to provide information about the product.

### CROSS-REFERENCE TO RELATED APPLICATIONS

This application claims priority to and the benefit of Australian provisional patent application no. 2009901529 filed Apr. 8, 2009, which is hereby incorporated by reference.

### FIELD OF THE INVENTION

This invention generally relates to displaying goods and in particular is concerned with displaying goods over a remote connection such as an internet connection.

### BACKGROUND TO THE INVENTION

Shopping online has become a popular alternative to physical stores. Many companies now have an online presence that allows potential clients to browse their good without leaving their home.

Typical online stores include a products section which normally includes an image and a brief description of a product being viewed. Based on the limited product information often contained on the online store websites a client must decide if they are going to purchase a particular product or whether they are going to continue looking. Such systems often provide limited product information with little, delayed or even no feedback.

An alternative to online shopping is to visit a store personally. This provides an opportunity to investigate the desired product more thoroughly, and for the client to ask questions relating to the product directly to a staff member. The drawback with this is the time required to travel to the store, to locate the goods within the store and to then return to the customer's original location once the purchase has been made. Other problems with this method are the store that is visited being out of stock of a desired product which results in time being lost.

Another option for retail companies is television shopping. This option is even more limiting than the two preceding options as this method only provides information on a limited range of products which often is pre-selected by the television network or by a company offering the advertised products for sale. With this option a shopper is not able to browse the advertised goods more closely apart from quickly viewing a screen shot of a product advertised during the commercial or infomercial segment. Also, any information provided of the product during the infomercial segment is often limited to scripted information which may not be relevant to a potential customer's questions. Furthermore, casual browsing of products displayed during the infomercial is not possible with televised shopping.

### SUMMARY OF THE INVENTION

Accordingly, it is an aim of the present invention to overcome or substantially ameliorate the disadvantages of the prior art.

The invention generally provides a goods displaying system which includes a first communications tool which is operable by a first user and at least a second, remote communications tool which is operable by a second user; a communications network allow the first communications tool be in communication with the at least second communications tool; and wherein product information is capable of being communicated from the first communications tool over the communications network to the second communications tool; and wherein the first user is able to selectively enable through the first communications tool two way communication between the first and second communications tools thereby allowing product information to be communicated to the second communications tool for communication to the second user through the second communications tool.

In accordance with the invention there is provided a method of remote retail sales using a telecommunications means and a control means in which the user is able to control the telecommunications means and provide or obtain retail service in a plurality of ways.

The retail service in a plurality of ways can include personal sales representative input, visual input, auditory input, data input and advertising input.

Preferably the user can control the supply of at least some of the plurality of ways of the retail service.

Preferably the user can control the obtaining of at least some of the plurality of ways of the retail service.

Preferably the method includes using a plurality of different telecommunication streams transmitted on the telecommunication means. The different streams can be sourced from different places and be coordinated and controlled by the control means for telecommunication.

The user could be a person which is situated at a remote location, for a customer at work or at home.

The user could be a staff member of a service provider of the retail service.

In one form of the invention there is provided a method of viewing displayed goods wherein a customer is able to obtain information and personal input while a user proceeds along a goods line to provide a remote retail service.

The customer makes use of a remote communications access device to obtain information from the user.

The user makes use of a communications tool that can be connected to the remote communications access device over a network.

The user is located at a position where the goods for display are located.

The present invention provides a method of displaying goods that includes the steps of: providing a communications tool being able to connect to a network enabled device which can receive multiple communication requests over a network from a remote communications access device wherein the communications tool is able to receive audio information from the network enabled device in real time when the communications tool is connected to the remote communications access device; using the communications tool to receive multiple communication requests and prioritising them according to contact time; using the communications tool to transmit video information, audio information and text information collected by peripheral video and peripheral audio devices driven by the communications tool and be used by a user in real time when the communications tool is connected to the remote communications access device over a network; wherein the user is able to selectively enable two way communication between the user and a person at a remote location through the communications tool and the user can use the video peripheral device to display goods to the person at a remote location allowing the person at a remote location to view products within the store from a remote location over a video connection viewable through a second communications tool and receive assistance relating to the viewed product from the staff member using the audio peripheral device.

The invention generally provides a method of displaying goods which includes the steps of: providing a communications tool being able to receive multiple communication requests over a network from at least one remote communications access device wherein the communications tool is able to receive audio information from the network enabled device in real time when the communications tool is connected to the remote communications access device; using the communications tool to receive multiple communication requests and prioritising them according to contact time; using the communications tool to transmit in real time video, when the communications tool is connected to the remote communications access device over a network, information, audio information and text information collected by peripheral video and peripheral audio devices being driven by the communications tool; and wherein the user is able to selectively enable through the communications tool two way communication between the user and, at a remote location, a person using the remote communications access device; wherein the user can use the video peripheral device to display goods to the person on the remote communications access device thereby allowing the person to view products within a store from the remote location over a video connection; and wherein the person is capable of receiving assistance from the user regarding the viewed product through the audio peripheral device.

The present invention provides means of displaying goods including: a communications tool being able to connect to a network enabled device which can receive multiple communication requests over a network from a remote communications access device; the communications tool is able to transmit video information and audio information to the network enabled device in real time when the communications tool is connected to the remote communications access device; the communications tool is able to receive audio information from the network enabled device in real time when the communications tool is connected to the remote communications access device; and peripheral video and peripheral audio devices driven by the communication tool able to be used by a user to collect visual and audio inputs for transmission by the user such that the user is able to selectively enable two way communication between the user and a person at a remote location through the communications tool and the user can use the video peripheral device to display goods to the person at a remote location allowing the person at a remote location to view products within the store from a remote location over a video connection viewable through a second communications tool and receive assistance relating to the viewed product from the staff member using the audio peripheral device.

The invention generally provides an apparatus for displaying goods and which includes a communications tool which is capable of connecting to a network and which is capable of receiving multiple communication requests over the network from a remote communications access device; the communications tool is able to transmit video information and audio information to the remote communications access device in real time when the communications tool is connected to the remote communications access device; the communications tool is able to receive audio information from the remote communications access device in real time when the communications tool is connected to the remote communications access device; and peripheral video and peripheral audio devices driven by the communication tool able to be used by a user to collect visual and audio inputs for transmission by the user; the communication tool is capable of allowing the user to selectively enable through the communications tool two way communication between the user and, a remote location, a person at using the remote communications access device; and wherein the user can use the video peripheral device to display goods to the person to allow the person through the remote communications access device to view products within a store from the remote location over a video connection; and wherein the user can provide assistance to the person regarding a viewed product using the audio peripheral device.

The communications tool is capable of sending and receiving text based information.

The sent text based information accessed from a database hosted on a server.

The communications tool is capable of receiving video information.

The communications tool is capable of receiving multiple requests for connection.

The communications tool includes a queuing function that will prioritize each un-answered contact according to time of contact.

The store is represented online in a virtual room hosted on a third party website.

The virtual room can be embedded in the private website of the store.

The staff member can list the virtual room as available or busy.

An alarm is activated at the store end when a person at a remote location enters the virtual room.

The person at a remote location can enter the virtual room by providing identifying details.

The identifying details are a valid email address and username.

The person at a remote location can leave a message if the virtual room is listed as busy.

The store can have a plurality of virtual rooms.

The person at a remote location can register to become a member of the service.

Registered person at a remote location s are given incentive packages such as loyalty programs and early entry to the virtual room at times non-registered members can not.

The internet enabled device used by the store staff member is a hand held personal device.

The video peripheral device is at least one web-cam.

The at least one web-cam is embedded in the hand held personal device.

The at least one web camera is a plurality of web-cams that are located about the store to provide multiple views of the interior of the store.

A queued person at a remote location can view the store through the plurality of web-cams while waiting to be recognized by the user.

The communication tool that pre-selects common audio and common video channels for both communication tools in communication.

The method makes use of the ActiveX internet plug in to facilitate streaming video and audio.

The store is a physical location that can be visited by the person at a remote location.

The present invention provides method of displaying goods that includes the steps of: providing a communications tool being able to connect to a network enabled device which can receive multiple communication requests over a network from a remote communications access device; using the communications tool to receive multiple communication requests and can prioritise them according to contact time; organizing any unanswered communication requests by a queuing function; using the communications tool to receive video information, audio information and text information from the network enabled device in real time when the communications tool is connected to the remote communications access device; using peripheral video and peripheral audio devices driven by the communication tool by a user to collect visual and audio inputs for transmission by the user; and the communications tool is able to transmit video information, audio information and text information to the user communications device in real time when the communications tool is connected to a remote communications access device over a network; such that the user is able to selectively enable two way communication between the user and a person at a remote location through the communications tool and the user can use the video peripheral device to display goods to the person at a remote location allowing the person at a remote location to view products within the store from a remote location over a video connection viewable through a second communications tool and receive assistance relating to the viewed product from the staff member using the audio peripheral device.

### BRIEF DESCRIPTION OF THE DRAWING

In order that the invention can be more readily understood an embodiment of the invention will be described by way of non-limiting example with reference to the Figures wherein:

FIG. 1 is a schematic representation of an apparatus in accordance with the invention; and

FIG. 2 is a flow diagram outlining the method according to an embodiment of the invention.

### DETAILED DESCRIPTION OF THE PREFERRED EMBODIMENTS

Although this system can be applied to many applications, for the purposes of the preferred embodiment it shall be described with reference to a retail situation.

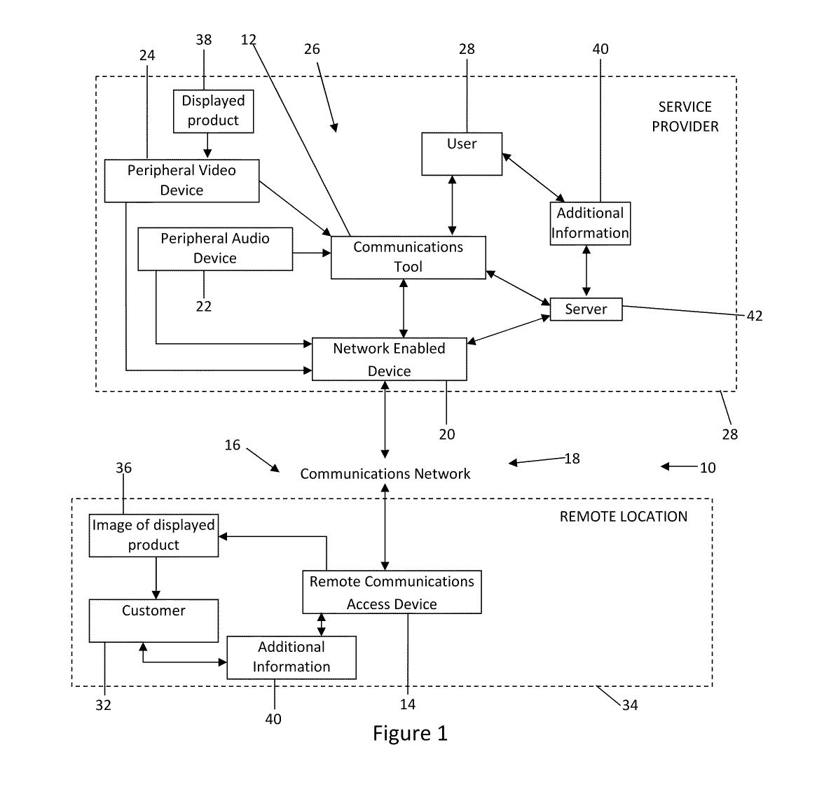

FIG. 1 illustrates a system 10 for remote sales in accordance with the invention. In the system, a control means or communications tool 12 (e.g., personal computer, mobile computer, cell phone, internet device, personal digital assistant) is used to communicate with a remote communications access device 14 (e.g., personal computer, mobile computer, cell phone, internet device, personal digital assistant) through a telecommunications means 16 in the form of a communications network (e.g., cell phone, satellite, intranet, metropolitan area network, cloud, WiFi, WiMax) or internet network 18. Use is made of a network enabled device 20 (e.g., router, hub, server, personal computer, mobile computer, cell phone, internet device) to allow one or more the communications tool 12 to communicate with the remote communications access device 14 via the network 18. However, in FIG. 1, the network enabled device is shown as a separate component but could equally be integral with the communications tool and the invention is therefore not limited in this regard.

The communications tool has access (e.g., couples to, communicates with) to a peripheral audio device 22 and/or a peripheral video device 24. The peripheral devices may be formed integrally with the communications tool, for example as a video camera and a microphone, but could equally be in the form of separate components which are attached, either wirelessly or using a wire network, to the communications tool. For example, in the latter instance the peripheral device may be one or more web-cameras and the peripheral audio device may be a headset or microphone. These peripheral devices may be associated with the telecommunications tool in any appropriate way. For example, the peripheral devices may be connected directly to the communications tool or may be controlled by way of the network enabled device.

The communications tool 12, in combination with peripheral audio and video devices 22 and 24 provides an apparatus 26 which allows a user 28 such a staff member of a service provider 30 to communicate information (e.g., video images, audio, text, data) to a customer 32 at a the remote location 34.

The user 28, using the apparatus 26, communicates images 36 of a displayed product 38 to the customer 32 for display on the remote communications access device 14. Typically such images will be communicated to the customer once the user receives a request from the customer regarding the display product 38. The remote access commutations device also allows the customer 32 to pose questions to the user about the product or request further or additional information 40 about the product. The user or staff member can then answer these questions to assist the customer in making its decision whether or not to buy the displayed product. In doing so the staff member may provide additional information 40 which may be communicated to the customer via the peripheral audio device 22 or maybe sent to the customer from a server 42 which draws the additional information from a database stored on the server. Typically the additional information may be in the form of advertisements, which may be drawn from information stored on the server 42, or useful information in the form of personal input which the staff member provides to the customer, for example a description of the displayed product, personal recommendations or the like.

It should be noted that although in FIG. 1 the server 42 and the network enabled device 20 are shown as separate components, these components can equally be integrated into one component and the invention is therefore not limited in the regard.

A communication tool may be controlled by a staff member of a store. One or more communication devices may communicate (e.g., transmit, receive) with a network enabled device. A staff member may control one or more communication tools to communicate with a customer. A communication tool may provide unidirectional or bidirectional communication with a remote communications access device. Communication may be real-time or near-real-time. A communication tool may communicate information (e.g., requests, data, video, audio, text). A communication tool may receive video information from a peripheral video device for communication. A communication tool may receive audio information from a peripheral audio device for communication.

A network enabled device may communicate information (e.g., requests, data, video, audio, text) with one or more communication tools. A network enabled device may communicate information with a remote communications access device. A remote communications access device may be controlled by a customer. A remote communications access device may communicate with a network enabled device via a network. A remote communications access device may communicate information. A remote communication may receive display information to a customer. A remote communication may receive an input (e.g., indication, selection) from a customer. A remote communication may communicate a customer input.

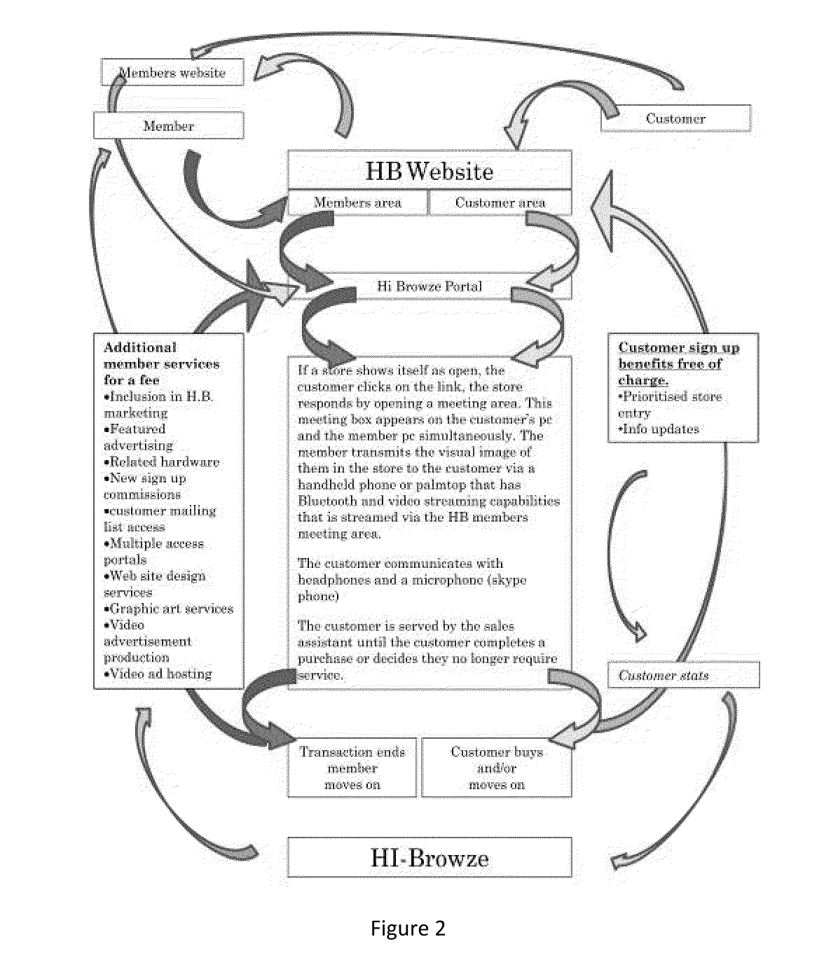

Referring to the FIG. 2, a method of displaying goods in a retail store is illustrated. The method includes the steps of having a communications tool controlled by a staff member of a store that is being able to connect to a network enabled device which can receive communication requests over a network from a second communications tool or remote communications access device controlled by a customer.

When in use, the communications tool includes peripheral video and peripheral audio devices driven by the communication tool. These peripheral devices are able to be used by the staff member to collect visual and audio inputs for transmission by the staff member to the customer. A staff member may selectively enable two-way (e.g., bidirectional) communication between the user and a remote customer through the communications tool. A staff member may use the video peripheral device to capture real time images and transmit the images to the customer's remote communications access device to display goods to the remote customer allowing the remote customer to view products within the store without having to be in the store. The customer can also receive assistance (e.g., information, description, pricing, use, availability) relating to the viewed product from the staff member using the audio peripheral device.

The method allows a customer to view displayed goods from a remote location while being able to obtain information and personal input from the staff member. In other words, the method makes it possible for a service provider to provide a remote service to its customers in which the customer can view displayed goods and ask questions about the displayed goods which are answered by the staff member. Information may include requests, data, video, audio, text or any combination thereof. The customer may make use of a remote communications access device to obtain information from the user. The user makes use of a communications tool that may be connected to the remote communications access device over a network. The user is located at a position where the goods for display are located.

The communications tool used by the user can also receive video information that is sent by the remote communications access device. When connected, the communications tool and the remote communications access device may communicate text base information. A communication tool may receive information from a database that his hosted on a server. A communication tool may communication information received from a database with a customer via a remote access communication device. The user may select and/or control the type of information send from the database to the customer. Information from the database may include product information, availability, product specifications, pricing, quantity, method of delivery (e.g., shipping, in-store pickup). Information may include financial information needed to complete a financial transaction between the user and the customer.

A communications tool may select a common video and audio channel for both the staff member and customer. A communication tool may establish a channel for communication between the communication tool, a network enabled device, and a remote access device. This results in removing the need for both the customer and staff member needing to manually select the channel. An ActiveX tool plug-in may be used to facilitate streaming video and audio. A streaming connection may be established such that both the video and audio communications may occur in real time. In one implementation, communications tool 12 uses Voice Over Internet Protocol (VOIP) as its primary communications protocol. Communications channels are established in accordance with the VOIP protocol.

A store that can be contacted by a customer may be represented in an online environment via a virtual room. A virtual room may be hosted on a third party server. A store may embed their virtual room into their own website if desired, or it may be hosted on a third-party website to form a virtual shopping mall. When part of a virtual shopping mall, the store's virtual room may be searched for through a search engine.

When a customer wants to access an open store or leave a message if they are unavailable they must log in with email and name only, this can be done if they are not a member. If they become a member however they gain privileges and their sales are tallied to give them special offers like gaining early entry to a store if there are several people waiting.

The first time a customer access a store online, the customer may have to download ActiveX or other streaming software to facilitate streaming video/audio on their remote communications access device. There are no further downloads for the customer. Once the customer clicks on a link to enter a store that is open, an alarm (e.g., audio, visual, data) is sent to the store and the store is free to allow entry to the customer. The customer's is given access to the meeting room that is immediately open to them for a private one-on-one meeting.

A store may have multiple virtual rooms depending on size or popularity of the store. A popular store may wish to have more than one virtual room to cater to the larger number of remote customers they may attract. A large store may wish to have several virtual rooms that are dedicated to specific departments within the store.

To contact the virtual room, a customer is required to enter identifying details. Details may include a user name and a legitimate email address. There is no restriction on what the customer can use as a username, but the email address is required to be legitimate to act as a contact point if any transactions occur, so that a receipt or other information may be sent to the customer. Further to this, the customer may register to become a member of the service and a specific store's virtual room. Registered customers can receive incentive packages that are not available to non-registered customers. These incentives may include special opening times that are for members only, special sales offers and discounts on items for members only.

The virtual room includes a visual display that indicates if the virtual room is available for use. When the virtual room is not available an appropriate message will be displayed as either words or a symbol. When available, an appropriate message that indicates this is shown. The message indicating if a virtual room is available or busy can be an automatic change when a contact is enabled or ended or it can be a manual action by the staff member staffing the virtual room.

The communications tool is capable of receiving multiple requests for connection from multiple customers at any given time. Thus if the room is listed as busy, other customers can still attempt to make contact with the communications tool. When this happens, the communications tool includes a queuing function that will prioritise each un-answered contact according to time of contact. The staff member will be able to monitor this queue to see how many people are waiting and who their next potential customer is.

If a virtual room is listed as busy, a customer can choose to enter a waiting queue, or alternatively leave a message providing information relating to their needs and request. The store staff member can reply to the message and this will be sent directly to the email address provided by the customer when attempting to contact the store's virtual room.

The store does not need be limited to an internet presence. It is possible for a store with a physical presence to make use of this system as a secondary form of customer interaction.

A communications tool used by a staff member may include a handheld personal device (e.g., cell phone, personal digital assistant, netbook, pad computer). Initial contact with a customer may be established through a laptop or desk top via an internet connection, but the connection may be transferred to the handheld personal device to allow the staff member the freedom to move about the store. The handheld device may include wireless technology such as WIFI Bluetooth and is powered by batteries. A mobile communications tool permits a user to communicate with a customer while moving about the store. Communication during movement enables the user to provide information about a physical location in a brick-and-mortar store or about products that are physically positioned in a store.

A peripheral video device may include a web-cam. A handheld device may include an embedded web-cam. A store may include a plurality of web-cams located about their premises. A staff member and/or a customer may select a web-cam for transmission to a staff member (e.g., user) or a customer. This allows for different views to be used that may show the store or specific products more effectively. A virtual room may include controls that can establish communication with a selected camera. A control may include a mouse, a touch screen, or graphical user interface presented on a screen of a communications tool and/or a remote communications access device. Although the retailer makes use of a web-cam, a customer may not have a web-cam or other video device at their end and may not have a need or desire to transmit their image. However, a customer may transmit video images to inform a user of products owned or desired by a customer to enable a user to provide more efficient and/or personal service to a customer.

The plurality of web-cams situated about a store may allow queued customers the option of browsing the store before being served. Once a staff member is ready to serve a queued customer, the customer will be notified and will be taken back to a starting position, which will be the view from the staff member's personal web-cam in a handheld device, to begin the service.

The web page the virtual room is viewed on also includes extra information and non-essential information. The extra information includes a link to a map website to provide location information, opening times and other products that are available. Non essential information in the form of advertising is also included.

When a customer contacts the store via a remote communications access device, the alarm will activate within the store. This can take many forms such as a flashing light, a sound alarm or a vibrating unit carried by the staff member staffing the virtual room. Once alerted, the staff member staffing the virtual room will review the virtual room and answer the contact, initiating the communication with the customer.

If a customer is willing to make a purchase, the store staff may receive account details relating to debit or credit information via a secure connection. This information will be typed in and received as text to the staff member's internet ready device. This is to avoid others overhearing the customer's account details. The purchase can then be picked up or delivered to the customer according to their requirements.

This method provides a retailer with the ability to function at any time. Staff can be hired to monitor the virtual room for international time zones, providing a greater customer base.

### An Implementation

An example of the implementation of the method and apparatus of the present invention will now be further described with reference to a virtual room scenario.

### Virtual Room Features and Functions.

The Virtual room site is evolving into a social network tool that will assist retailers and traders in general—including wholesalers, home stores, ebayers, casual sellers, hobby or specialist clubs and groups, professional retail outlets, chain stores, department stores, franchises and all business that involves interaction for trade purposes in any capacity.

The Site offers three methods of membership, a visitor membership, a standard membership and a full virtual room membership.

For a visitor's membership—When visitor enters the site they have a choice of stores standard and virtual room members on the front page of whom they can view the profiles, images videos and business store information. The visitor may also choose to see only virtual room members, only standard members, or both standard and virtual room members.

The store links and profiles show whether they are online offline or busy.

The visitor may search in the quick search box for a particular profile type—all, a standard profile (without webcam), or a virtual room—with a web cam; a user name; country; state; city; status—online offline or busy; language; and with photos only.

When a visitor enters a profile they see the profile's profile page, images and videos that the profile has uploaded, store information. If the visitor wants to enter a store for a chat meeting they must log in first, this is a quick and easy log in with only username, password and email required. For this they do not get a profile.

To enter a virtual room chat room, the visitor must log onto virtual room. There are 3 different ways to log into virtual room: 1) visitor membership; 2) standard profile; and virtual room profile.

### Visitor Membership

The information required for the application to log in includes username, password, email. Visitor membership does not offer a profile page. Visitors have the following use of the site—make search, play video, send greetings, send messages, use chat, use forum, use guestbook, use instant messenger, view blogs, view members guestbook's, view photos, view member profiles, photos, videos, vote on profiles, photos and videos, visit virtual rooms.

### Standard Profile

the information required for the application for a standard log in is as follows:

Choose a profile type.

Enter the following information: username, email, PayPal email, password, category, city, zip code, country, state, language, and catchphrases. The fee for this is waived for the first year of use.

The features available to a standard profile include—post, edit and remove own comments, vote on comments, make a search, rate photos, send greetings, send messages, upload photos, use the blog, user the forum, use the guestbook, view other members Blog, view photos, view profiles, vote, visit Virtual room's. Create groups, link to other profiles, invite a friend, join the affiliate program and earn 20% of all signs up from invites. Add a description of my business and a Google add link, add a category for my store to be listed in the profile search tool, add my business information such as—store name, email address, phone number, mobile number, city, address, website link, suggest a category, add my fax, Google maps link. Have members link to each other—standard and virtual room profiles. Block members. See who views profile, up to 20 photos may be added to each profile page. Up to 100 messages may be stored in the inbox; Classifieds may be listed for 30 days.

### Virtual Room Profile

The information required for the application for a full virtual room profile membership is as follows—username, email, PayPal email, password, category, city, zip code, country, state, language, and catchphrases. Plus a fee.

The features available to a standard profile are—can add and delete classifieds, post, edit vote and remove comments, make search, play music, play video, rate photos, send greetings, send messages, upload music, upload photos, upload videos, use blog, use chat, use forum, use gallery, use guestbook, use video player, view other members blog, view other members gallery, view other members guest books, view photos, view profiles, vote, create groups, link to other profiles, invite a friend, join the affiliate program and earn 20% of all signs up from invites. Add a chat room link directly from my web site to my chat room bypassing the virtual room web site. Add a description of my business and a Google add link, add a category for my store to be listed in the profile search tool, add my business information such as—store name, email address, phone number, mobile number, city, address, website link, suggest a category, add my fax, Google maps link. Have members link to each other—standard and virtual room profiles. Block members. See who views profile, up to 20 photos may be added to each profile page. Up to 100 messages may be stored in the inbox; Classifieds may be listed for 30 days.

To use the virtual room chat function a member must be a virtual room profile member. When the virtual room member logs on, they automatically go to their account page. To activate the virtual room chat room the member clicks on the “open my virtual room chat window” link. A new widow appears—the user is asked to allow camera and microphone access. Once allow is clicked, the user sees themselves on the screen that also has the following functions—

The user can choose how they wish to be shown on the site—busy, or offline. To the left of the video screen is a chat history window for text communication, this screen has editing functions such as emoticons, bold, italic, and underline, plus text left alignment, centered alignment and right alignment.

To the right of the chat window is a customer queue. Each time a customer requests entry to the store chat room their profile appears in this queue, the virtual room member may grant entry to anyone in the queue no matter what position. To accept a customer the Virtual room member clicks on the customer profile in the customer list and a message is sent to the member.

In one implementation of the invention, a system for remote shopping enables a customer at a remote location to shop for a product located in a store, wherein a staff member at the store provides the customer assistance in shopping, the system comprising: a communications tool comprising a video device and an audio device, the communications tool positioned at the store; a network device positioned at the store, the network device communicates with the communications tool and a network; a remote communications device positioned at the remote location, the remote communications device communicates with the communications tool via the network and the network device; wherein: the product is located in the store; responsive to a question from the customer, the staff member provides information about the product; and information about the product comprises at least one of video images of the product, still images of the product, data regarding the product, product specifications, a comparison of the product with similar products, and an answer provided by the staff member to the question asked by the customer.

The above implementation, wherein responsive to a request from the customer, the staff member provides information about a next product.

The above implementation, wherein the staff member response to a question from the customer in near real-time.

While we have described herein a particular embodiment of a method for selectively displaying goods it is further envisaged that other embodiments of the invention could exhibit any number and combination of any one of the features previously described. Examples listed in parentheses may be used in the alternative or in any practical combination. However, it is to be understood that any variations and modifications can be made without departing from the spirit and scope thereof.

What is claimed is:

1. A method for accomplishing remote retail sales, the method comprising:
using a telecommunications means; and
using a control means operated by a user to control the telecommunications means to perform the retail service, the retail service selected from at least one of a personal sales representative input, a visual input, an auditory input, a data input, and an advertising input.

2. The method of claim 1 wherein the user controls the selection of the retail service.

3. The method of claim 1 further comprising using a plurality of different telecommunication streams transmitted on the telecommunication means to perform the retail service.

4. The method of claim 3 wherein the plurality of different streams is sourced from different places and is coordinated and controlled by the control means for communication to a remote communications access device.

5. The method of claim 1 wherein the user is selected from any one of the following: a person situated at a remote location, and a staff member of a service provider of the retail service.

6. A method for displaying goods, the method comprising:
providing a communications tool that receives multiple communication requests over a network from at least one remote communications access device wherein the communications tool is able to receive audio information from the remote communications access device in real-time when the communications tool is connected to the remote communications access device;
using the communications tool to receive multiple communication requests and prioritizing them according to contact time;
using the communications tool, while the communications tool is connected to the remote communications access device over a network, to transmit in real-time video information, audio information and text information collected by peripheral video and peripheral audio devices being driven by the communications tool; and wherein the user is able to selectively enable through the communications tool two way communication between the user and, at a remote location, a person using the remote communications access device; wherein the user can use the video peripheral device to display goods to the person on the remote communications access device thereby allowing the person to view products within a store from the remote location over a video connection; and wherein the person is capable of receiving assistance from the user regarding the viewed product through the audio peripheral device.

7. An system for displaying goods, the system comprising:
a communications tool that connects to a network and receives multiple communication requests over the network from a remote communications access device; the communications tool is able to transmit video information and audio information to the remote communications access device in real-time when the communications tool is connected to the remote communications access device; the communications tool is able to receive audio information from the remote communications access device in real-time when the communications tool is connected to the remote communications access device;
a peripheral video device; and
a peripheral audio device, the peripheral video device and the peripheral audio device driven by the communication tool able to be used by a user to collect visual and audio inputs for transmission by the user; wherein:
the communication tool is capable of allowing the user to selectively enable through the communications tool two-way communication between the user and, at a remote location, a person using the remote communications access device;
the user can use the video peripheral device to display goods to the person to allow the person through the remote communications access device to view products within a store from the remote location over a video connection; and
the user can provide assistance to the person regarding a viewed product using the audio peripheral device.

8. The system of claim 7 wherein the communications tool:
connects to a network enabled device; and
the communications tool communicates with the remote communications access device through the network enabled device.

9. The system of claim 7 wherein:
the communications tool is capable of sending and receiving text based information; and
the text base information sent is accessed from a database hosted on a server.

10. The system of claim 7 wherein the communications tool is capable of receiving video information.

11. The system of claim 10 wherein the communications tool includes a queuing function that will prioritize each un-answered requests for connection according time of request.

12. The system of claim 7 wherein the store is a virtual room hosted on a third party website or is embedded in a private website of the store.

13. The system of claim 12 wherein the user can list the virtual room as available or busy.

14. The system of claim 12 which includes an alarm which is activated at the store when the person enters the virtual room.

15. The system of claim 15 wherein the person is only allowed access to the virtual room by providing identifying details, and wherein the identifying details comprise at least one of valid email address, username, name, surname, address, and telephone number.

16. The system of claim 13 wherein the person can leave a message if the virtual room is listed as busy.

17. The system of claim 12 wherein the person is required to register with the virtual room in order to become a member of the retail service.

18. The system of claim 12 wherein:
the communications tool comprises a handheld personal device;
the video peripheral device comprises at least one web-cam, and
the at least one web-cam is embedded in the handheld personal device.

19. The system of claim 12 wherein the video peripheral device comprises a plurality of web-cams which are located through the store to provide multiple view of an interior of the store.

20. The system of claim 19 wherein the person, once queued and waiting for a response from the user, is capable of viewing the store through the plurality of web-cams while waiting for the response from the user.
